(19) United States
(12) Patent Application Publication
(10) Pub. No.: US 2007/0210161 A1
(43) Pub. Date: Sep. 13, 2007

(54) Multi card reader

(76) Inventor: William Page, Wellington, FL (US)

Correspondence Address: MCHALE & SLAVIN, P.A., 2855 PGA BLVD, PALM BEACH GARDENS, FL, 33410, US

(21) Appl. No.: 11/683,208

(22) Filed: Mar. 7, 2007

Related U.S. Application Data
(60) Provisional application No. 60/780,274, filed on Mar. 7, 2006.

(51) Int. Cl. G06K 7/00; G06K 7/06; G06K 7/08

(52) U.S. Cl. 235/440; 235/441; 235/449

(57) ABSTRACT

The present invention is a card reader that can read cards wherein the information contained on the cards is in different formats. This eliminates the need for different card readers for each card having a different format for information storage thereon. The card reader also has a biometric identification input and a keypad for input of additional information by a user of the device. The card reader further includes a data module connectable to the card reader. The data module includes various output connections to permit data transfer from the card reader to various processors

### CROSS REFERENCE TO RELATED APPLICATIONS

This application claims the benefit of U.S. Provisional Application No. 60/780,274, entitled “Mag-Smart Reader” filed on Mar. 7, 2006 the entire disclosure of which is herein incorporated by reference.

### FIELD OF THE INVENTION

This invention relates to devices that can read information stored on cards or discs which employ different formats. Some cards utilize magnetic strips, some utilize bar codes, some utilize smart card formats and some utilize proximity sensors. Currently there is no single reader that can read all these different formats.

### BACKGROUND OF THE INVENTION

It is apparent that the population is embracing a society where credit and debit cards are the preferable method of transacting business. For this reason, the technology with cards for use in identification of credit accounts, debit accounts, even personal information, including health issues, contact issues, employment issues, driving privileges, access privileges and so forth have created a maraud of devices necessary to read and interpret the individual card. A major problem lies with cards which employ different formats for storing information on the cards. For example, one credit card company may employ a magnetic strip for information storage while another credit card company or bank may employ a smart card circuit to store the same information on their credit card. A third type of information storage is in the form of a bar code. These different formats present a problem to merchants. They must purchase and utilize different card readers to be able to accept credit and/or debit cards from all different companies and banks. The cost of these different card readers can be prohibitive and the space necessary to located the different card readers near the points of transaction may not always be available. As the ability to store information has rapidly increased the amount of information available on credit cards, drivers' licenses, medical ID cards, etc. has also rapidly increased. The different information formats employed by these different cards presents a problem to the persons desiring to download the information. Each different format now requires a different card reader.

Thus what is lacking in the art is a device capable of reading all the different information bearing formats including magnetic strips, bar codes, smart cards, biometrics, WIEGAND, MIFARE, etc.

### DESCRIPTION OF THE PRIOR ART

U.S. Pat. No. 7,048,187, issued to Yu discloses a multi-card reader. The reader is designed to accept and read different memory cards which have diverse specifications, i.e. shape, thickness, width, length, and pin location. Different sized slots located at one end of the card reader allow for the insertion of memory cards having different specifications. Connecting terminals are associated with the different slots so that when a memory card is inserted into the proper slot the connection terminals will contact the contact elements on the card.

U.S. Published Patent Application No. 2005/0258243, filed by Hsich discloses a multi-card reader. The reader is constructed and arranged to accept a plurality of different memory cards having different specifications. One end of the card reader is constructed to accept the different widths of the memory cards. Connecting terminals at located at different positions within the card reader to contact the contacts elements of the memory cards. The card reader is also provided with an information output 54 at another end of the reader.

### SUMMARY OF THE INVENTION

A card reader has been developed that can read cards wherein the information contained on the cards is in different formats. This eliminates the need for different card readers for each card having a different format for information storage thereon. The card reader also has a biometric identification input and a keypad for input of additional information by a user of the device. The card reader further includes a data module connectable to the card reader. The data module includes various output connections to permit data transfer from the card reader to various processors.

Accordingly, it is an objective of the instant invention to provide a card reader which can read various different information formats.

It is a further objective of the instant invention to provide a card reader which also includes a data module that can transfer data withdrawn from a card to various processors.

It is yet another objective of the instant invention to provide a card reader which also includes a biomatrics input.

It is a still further objective of the invention to provide a card reader which includes a keypad for additional information input.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top view of the upper member of the card reader system of the present invention;

FIG. 2 is a top view of the lower member of the card reader system of the present invention and

FIG. 3 is a top view of the data module of the card reader system of the present invention.

### DETAILED DESCRIPTION OF THE INVENTION

There are currently a large number of identification cards, bank cards and cards which contain information that needs to be accessed by different individuals. Many of these cards employ different formats to store and provide access to the information. Some of the formats currently employed are magnetic strip, bar code, proximity sensors, MIFARE, smart card, CAT ID's, biometric, alphanumeric input, WIEGAND and Bluetooth wireless. Theses different formats are utilized in conjunction with bank cards, credit cards, debit cards, identification cards, driver's licenses, passports, health provider cards, casino cards, loyalty cards, transportation fare cards, etc. The card reader employees an open platform which supports multiple industry card standards (ISO) and biometric standards.

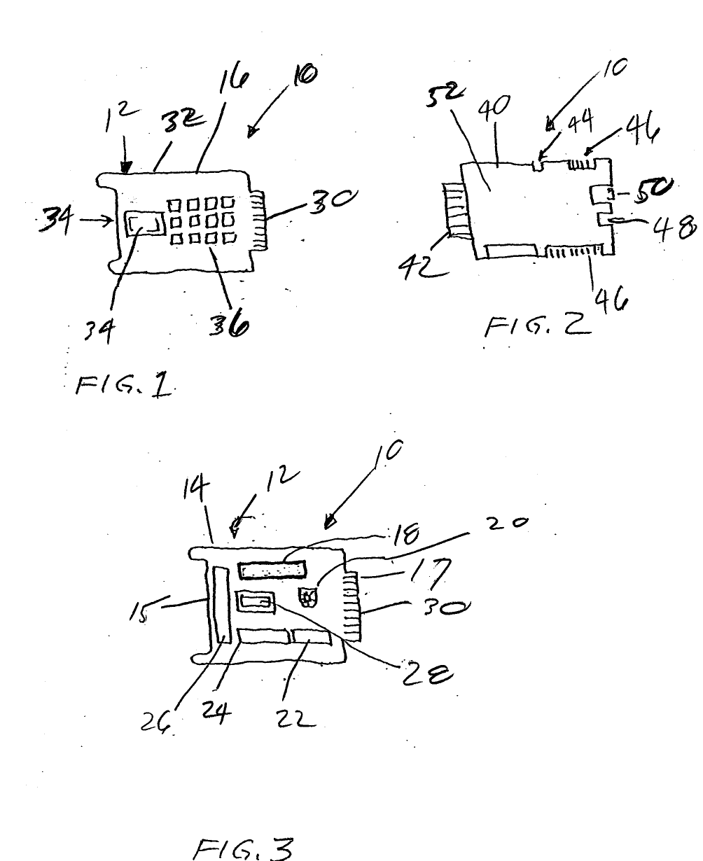

The lower portion or member of the card reader 12 element of card reader system 10 is illustrated in FIG. 2 as 14. The upper portion or member of the card reader 12 element of card reader system is illustrated in FIG. 1 as 16. The lower member includes a front end 15 and a back end 17. The upper surface of the lower member includes multiple information medium readers positioned at various locations thereon. Reader 18 is designed to read and obtain the information on the magnetic strips on various cards. Reader 20 is designed to read and obtain the information on smart cards with or without contact of the smart card. Reader 22 is designed to read a WIEGAND card. This is a card which employs embedded wires formed from specific alloys. These alloys impart magnetic properties to the wires which enable them to store information thereon. Reader 24 is designed to read bar codes and obtain information from the bar codes. Reader 26 is a proximity sensor designed to read and obtain information from MIFARE cards and/or RFID devices. The MIFARE cards are widely used as fare cards on transportation systems and the RFID devices are employed to wirelessly transmit information. Reader 28 is designed for reading biometric information. All of the information obtained from the various readers is sent to the data module through connector 30 at the back end of the lower member.

The lower member is secured to the upper member 32, illustrated in FIG. 1. The lower member preferably has the same outer shape as the upper member. Other shapes are also contemplated. The lower member can be secured such that the upper surface of the lower member is adjacent the lower surface of the upper member, in a preferred embodiment, or such that the lower surface of the lower member is adjacent the lower surface of the upper member, in another embodiment. In the first position, identification and bank cards are slid between the upper and lower members at 34, as illustrated in FIG. 1. In the second position, the various cards are positioned adjacent the surface of the lower member which contains the various readers. In another embodiment the readers 18-28 can be located on the lower surface of the upper member 16. The upper member 32 also contains a biometric reader 34 designed to read various biometric inputs. An alphanumeric input or keypad 36 is also mounted to the upper surface. The user can input various information using numbers and/or letters on the keypad 36. The upper member 32 is also provided with a connector 30 for the data module 40.

The data module 40 is also an element of the card reader system 10. The data module 40 provides various connections or connectors to enable the information obtained by the card reader 12 to be sent to various processing devices. Connector 42 on the front end of the data module 40 is constructed to be connectable to and engage connector 30 of the card reader 12. The various output connectors include a USB connector 44, a serial port connector 46 and a RS 232/485 connector. Connector 48 enables the output from the data module to be connected to a modem, such as those employed in conjunction with a public telephone system. Connector 50 enables the data to be sent to networks, such as a local area network or a wide area network Connector 50 also enables the data module to be connected to the Internet so as to provide global connections. Data module also includes a wireless Bluetooth communication connection 52.

Once the data arrives at the processors it can be used for various functions such as financial transactions, identification purposes, etc. Financial transactions at banks, retail establishments, gas stations, hotels and casinos are readily enabled by the present invention. Control of access to various buildings and areas is provided by the present invention. Verification of identification of individuals at entry points of buildings and other areas can be established and confirmed utilizing the contact or proximity sensors of the present invention. Additional applications would be for “on the spot” identification at border crossings, immigration check points and cruise ship travel.

Biometric information could be used for both identification and health information. When employed for health information the biometric readers would be employed to identify an individual and release their health information to authorized individuals, such ad doctors, hospitals and emergency medical services personnel. These individuals would use the alphanumeric keypad 36 or Bluetooth connection to enter their authorization codes into the card reader.

Additional users of identification verification would be correction officers, DEA, ATF, FEMA and law enforcement employees. The wireless transmission would be employed for wireless transmission of biometric data for identification verification at high security areas such as naval ports, nuclear power facilities, airports, etc.

Sporting and entertainment events management could employ this invention for identification verification to ensure ticket purchases, identify seating, authorize access to VIP areas and verify the age of the cardholder.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A card reader system comprising:
a receptacle housing having an upper member, a lower member, a front end and a back end;
said front end being constructed and arranged to receive a removable card, said removable card including an information bearing medium thereon;
said back end constructed and arranged to transmit data, including information obtained from said removable card;
said upper member including a biometric input and a numerical keypad;
said lower member including multiple information bearing medium readers positioned at different locations on said lower member, each said information bearing medium reader constructed and arranged to read a different information bearing medium format;
said information bearing medium readers being alignable with a compatible information bearing medium on said removable card;
said back end of said receptacle housing coupled to a data transmission module, said data transmission module including a input for receiving data and information from said receptacle housing and multiple outputs for transmitting said data and information to various processing devices;
whereby multiple cards including different information bearing medium formats can be read by said card reader system and information obtained from said cards can be transmitted to various processing devices.

2. The card reader system of claim 1, wherein said information bearing medium is a magnetic strip.

3. The card reader system of claim 1, wherein said information bearing medium is a bar code.

4. The card reader system of claim 1, wherein said information bearing medium is a smart card.

5. The card reader system of claim 1, wherein said information bearing medium is a proximity sensor.

6. The card reader system of claim 1, wherein said information bearing medium is a biometric.

7. The card reader system of claim 1, wherein said information bearing medium is a Wiegand effect.

8. The card reader system of claim 1, wherein said information bearing medium is a RFID device.

9. The Card reader system of claim 1, wherein said information bearing medium is a Bluetooth communication device.

10. The card reader system of claim 1, wherein said output for transmitting data is a USB connector.

11. The card reader system of claim 1, wherein said output for transmitting data is a serial port connector.

12. The card reader system of claim 1, wherein said output for transmitting data is a telephone modem.

13. The card reader system of claim 1, wherein said output for transmitting data is a RS232 connector.

14. The card reader system of claim 1, wherein said output for transmitting data is a network connector.

15. The card reader system of claim 1, wherein said output for transmitting data is a Bluetooth connection.
